(19) United States
(12) Patent Application Publication
(10) Pub. No.: US 2011/0010378 A1
(43) Pub. Date: Jan. 13, 2011

(54) TREND CHARTING SYSTEM AND METHOD

(76) Inventor: John Dukes, Cohasset, MA (US)

Correspondence Address: ITALIA IP, 3500 WEST OLIVE AVE., SUITE 300, BURBANK, CA, 91505, US

(21) Appl. No.: 12/499,019

(22) Filed: Jul. 7, 2009

(51) Int. Cl. G06F 17/30; G06F 15/16

(52) U.S. Cl. 707/759; 709/203; 705/10; 707/769; 707/713

(57) ABSTRACT

A trend charting system includes one or more participant terminals operable to act as a client on a network and a computer operable to act as a server on the network and to communicate with each of the participant terminals over the network. The computer includes a memory configured to store a set of instructions and a processor configured to execute the set of instructions. The set of instructions cause the processor to: receive one or more search terms; search one or more databases for each search term; create a search result, wherein the search result includes the number of instances each search term has been found in each database and a date associated with each of said instances; and generate a search result chart based on the search result. A system, method and device are disclosed.

### BACKGROUND OF INVENTION

This application relates generally to monitoring trends. More specifically, this application relates generally to graphically displaying trends related to one or more search terms or keywords.

### SUMMARY

Recognizing and monitoring trends can often be an important aspect of predicting future behavior. One area where this may be of particular interest is in financial analysis and decision making. However, this is not always easily accomplished. For example, with respect to Security and Exchange Commission (SEC) filings, it is very difficult to recognize and/or monitor trends as the SEC databases simply provide long text listings. Given that most human beings are more equipped to recognize and/or monitor trends when the information is presented in a graphical or pictorial arrangement, such text listings are virtually useless. Therefore, there exists a significant need for a system and method for searching such databases for relevant information and presenting the relevant information in a format whereby a user may identify and/or monitor one or more trends.

In particular, this application discloses a trend charting system comprising: one or more participant terminals operable to act as a client on a network; a computer operable to act as a server on the network and to communicate with each of the participant terminals over the network, the computer comprising: a memory configured to store a set of instructions; and a processor configured to execute the set of instructions, wherein the set of instructions cause the processor to: receive one or more search terms; search one or more databases for each search term; create a search result, wherein the search result comprises the number of instances each search term has been found in each database and a date associated with each of said instances; and generate a search result chart based on the search result.

This application also discloses a trend charting device comprising: a memory configured to store a set of instructions; and a processor configured to execute the set of instructions, wherein the set of instructions cause the processor to: receive one or more search terms; search one or more databases for each search term; create a search result, wherein the search result comprises the number of instances each search term has been found in each database and a date associated with each of said instances; and generate a search result chart based on the search result.

This application further discloses a computer program product, comprising a computer usable medium having a computer readable program code embodied therein, said computer readable program code adapted to be executed to implement a method for charting a trend, said method comprising: receiving one or more search terms; searching one or more databases for each search term; creating a search result, wherein the search result comprises the number of instances each search term has been found in each database and a date associated with each of said instances; and generating a search result chart based on the search result.

### BRIEF DESCRIPTION OF THE DRAWINGS

The drawings, when considered in connection with the following description, are presented for the purpose of facilitating an understanding of the subject matter sought to be protected.

FIG. 1 is an illustration of a trend charting system;

FIG. 2 is an illustrative flow-diagram of a trend charting method; and

FIG. 3 is an illustrative trend chart.

### DETAILED DESCRIPTION

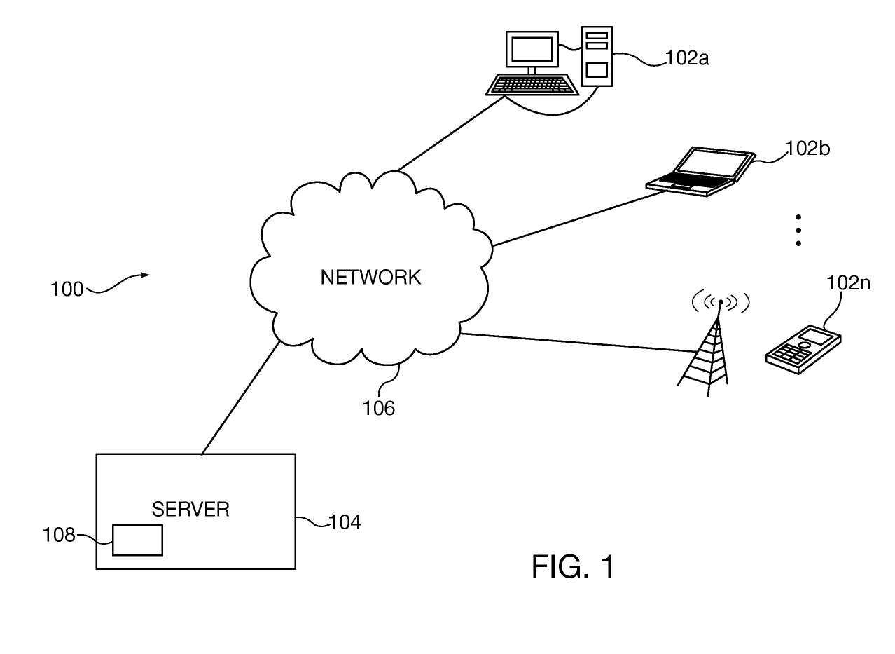

Referring now to FIG. 1, a trend charting system 100 is depicted. The system may include one or more terminals 102a-102n (collectively 102), a server 104, and a communications network 106. The different elements and components of the system 100 may communicate with one another using wireless communications or hardwired connections, such as fiber optics, cable, DSL, telephone lines, and other similar connections.

The communications network 106 may include any number of networks capable of providing communications between the server 104 and terminals 102. For example, the communications network may be one or more, or any combination of, wireless networks, data or packet networks, publicly switched telephone networks (PSTN), etc.

The participant terminals 102 may include any suitable device operable to act as a client on a network. Illustrative terminals 102 include, but are not limited to, personal computers, desktop computers, laptop computers, servers, or any suitable telecommunications device, including, but not limited to, VoIP telephones, smart telephones or wireless devices, such as cellular telephones, personal digital assistants (PDA), communications enabled mp3 players, etc. Each terminal 102 may be configured to transmit and/or receive information to and/or from the server 104 and/or other participant terminals 102.

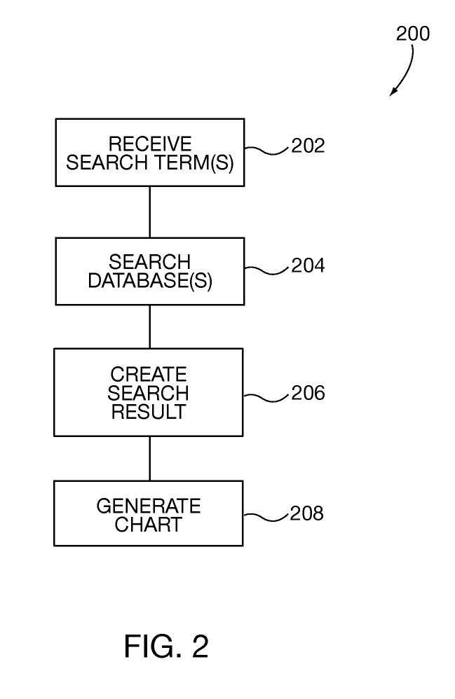

With particular reference to FIGS. 1-2, the server 104 may be any server, computer or device configured to process commands from the participant terminals 102. For example, the sever 104 may be operable to receive one or more search terms from one or more terminals 102 [step 202] and search one or more databases 108 for each search term [step 204]. A user may input one or more search terms into a text entry field displayed at one or more terminals 102. Alternatively, a user may select one or more search terms from one or more drop-down menus comprising a list or library of predetermined search terms. It will, however, be appreciated that any suitable means for receiving one or more search terms from one or more users at one or more terminals may be employed and remain within the scope of the present disclosure. In one embodiment, along with the one or more search terms, a user may input a specified time period to limit the scope of the search such that the server 104 searches for reported activity having occurred or been reported within said time period. The search may also be limited in scope via other terms or conditions, including but not limited to, company or business name, SEC form type or name, SEC Central Index Key number (CIK), SEC Standard Industrial Classification code (SIC), etc. In an alternative embodiment, one or more predetermined keywords or search terms may be automatically searched at predetermined intervals (e.g., daily, weekly, monthly, etc.) by the server.

The database(s) 108 may be stored on the server 104 or in a separate location apart from the server 104. In one non-limiting example, the one or more databases 108 store information related to Security Exchange Commission (SEC) filings, which may include information for one or more SEC form types. In one embodiment, the search terms may be financial keywords or terms related to the business or financial activity of one or more companies, business institutions, financial institutions, etc. Each database 108 may be configured to receive and/or store information related to the business or financial activity of one or more companies, business institutions, financial institutions, etc. wherein at least a portion the business or financial activity includes the date of the activity and/or the date the activity was reported to or inputted into each database.

Once the database(s) 108 have been searched, the server 104 may create a search result [step 206]. In one embodiment, the search result includes the number of instances each search term has been found in each database. Additionally, in one embodiment, the search result includes a date associated with each of the instances that each search term has been found. The date may be any suitable date. For example, the date may be the date of the occurrence of the business or financial activity associated with each search term, the effective date of the business or financial activity associated with each search term, etc. Alternatively, the date may be the date the business or financial activity associated with each search term was stored in the database. However, it will be appreciated that the forgoing dates are illustrative only and that any suitable date or dates may be employed and remain within the scope of the present disclosure.

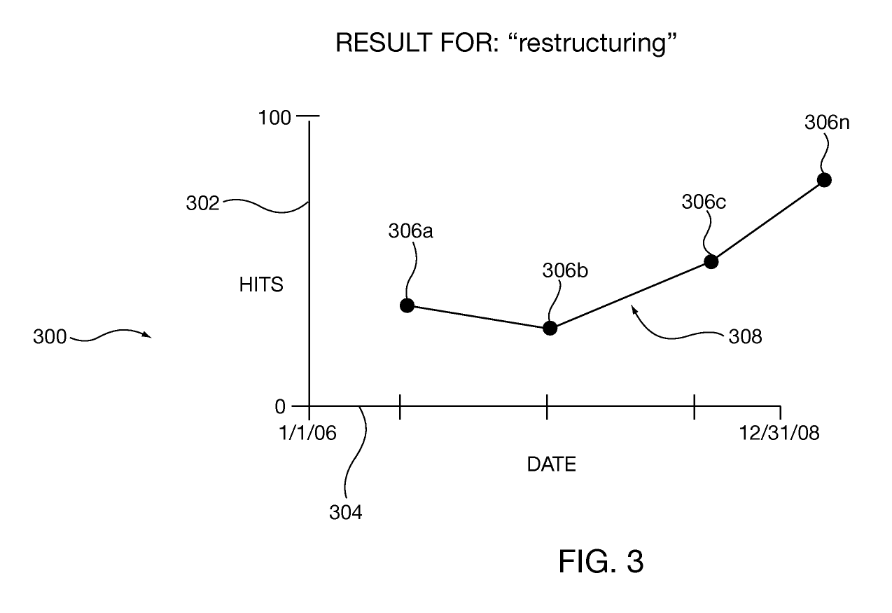

Once the search result has been created, the server 104 may generate a search result chart [step 208]. The search result chart may be any suitable graphical representation of the search result for display at one or more terminals 102 and/or any other suitable device capable of displaying the search result chart. FIG. 3 depicts an illustrative search result chart 300. In the illustrative chart 300, the y-axis 302 illustrates the number of instance a search term (e.g., “restructuring”) was found in the database(s). The x-axis 304 illustrates a specified timeline over which the search was conducted. Each point 306a-306n (collectively 306) on the chart 300 indicates the number of times the search term was found on a given date. Alternatively, each point 306 may represent the number of times the search term was found over a discrete time period (e.g., week, month, quarter, etc.); in one non-limiting example, if the search was conducted over one calendar year, each point 306 may represent the number of times a search term was found during each month. The points 306 may be connected to generate a line 308 so that a user may, in at least some instances, identify one or more trends related to one or more search terms over a specified time period. While the illustrative chart is a line graph, it will be appreciated that any suitable charting or graphing technique may be employed and remain within the scope of the present disclosure. For example, and without limitation, the chart may be a bar graph, a pie chart, column chart, stock chart, column and line chart, etc.

In the illustrative embodiment, the server 104 includes a memory and a processor to accommodate the forgoing. However, it will be appreciated that the forgoing may be implemented in hardware, software, or a suitable combination of hardware and software, and which can be one or more software systems operating on a general purpose server platform. As used herein, a hardware system can include discrete semiconductor devices, an application-specific integrated circuit, a field programmable gate array or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A trend charting system comprising:
one or more participant terminals operable to act as a client on a network;
a computer operable to act as a server on the network and to communicate with each of the participant terminals over the network, the computer comprising:
a memory configured to store a set of instructions; and
a processor configured to execute the set of instructions, wherein the set of instructions cause the processor to:
receive one or more search terms;
search one or more databases for each search term;
create a search result, wherein the search result comprises the number of instances each search term has been found in each database and a date associated with each of said instances; and
generate a search result chart based on the search result.

2. The system of claim 1 wherein the search result chart is a line graph, a bar graph, a pie chart, a column chart, a stock chart, or a column and line chart.

3. The system of claim 1 wherein at least one database comprises data from the Securities and Exchange Commission.

4. The system of claim 1 wherein the set of instructions further cause the processor to receive one or more dates for limiting the scope of the search.

5. The system of claim 1 wherein the set of instructions further cause the processor to receive the name of one or more companies for limiting the scope of the search.

6. The system of claim 1 wherein the set of instructions further cause the processor to receive one or more Securities Exchange Commission form names for limiting the scope of the search

7. The system of claim 1 wherein the set of instructions further cause the processor to receive one or more Securities Exchange Commission Central Index Key numbers for limiting the scope of the search.

8. The system of claim 1 wherein the search result chart comprises a x-axis and a y-axis, wherein the x-axis illustrates a timeline over which the search was conducted and the y-axis illustrates the number of instances that each search term has been found in the search.

9. A trend charting device comprising:
a memory configured to store a set of instructions; and
a processor configured to execute the set of instructions, wherein the set of instructions cause the processor to:
receive one or more search terms;
search one or more databases for each search term;
create a search result, wherein the search result comprises the number of instances each search term has been found in each database and a date associated with each of said instances; and
generate a search result chart based on the search result.

10. The device of claim 9 wherein the search result chart is a line graph, a bar graph, a pie chart, a column chart, a stock chart, or a column and line chart.

11. The device of claim 9 wherein at least one database comprises data from the Securities and Exchange Commission.

12. The device of claim 9 wherein the set of instructions further cause the processor to receive one or more dates for limiting the scope of the search.

13. The device of claim 9 wherein the set of instructions further cause the processor to receive the name of one or more companies for limiting the scope of the search.

14. The device of claim 9 wherein the set of instructions further cause the processor to receive one or more Securities Exchange Commission form names for limiting the scope of the search

15. The device of claim 9 wherein the set of instructions further cause the processor to receive one or more Securities Exchange Commission Central Index Key numbers for limiting the scope of the search.

16. The device of claim 9 wherein the set of instructions further cause the processor to receive one or more Securities Exchange Commission Standard Industrial Classification codes for limiting the scope of the search.

17. The device of claim 9 wherein the search result chart comprises a x-axis and a y-axis, wherein the x-axis illustrates a timeline over which the search was conducted and the y-axis illustrates the number of instances that each search term has been found in the search.

18. A computer program product, comprising a computer usable medium having a computer readable program code embodied therein, said computer readable program code adapted to be executed to implement a method for charting a trend, said method comprising:
receiving one or more search terms;
searching one or more databases for each search term;
creating a search result, wherein the search result comprises the number of instances each search term has been found in each database and a date associated with each of said instances; and
generating a search result chart based on the search result.

19. The method of claim 18 wherein the search result chart is a line graph, a bar graph, a pie chart, a column chart, a stock chart, or a column and line chart.

20. The method of claim 18 wherein at least one database comprises data from the Securities and Exchange Commission.
